(19) United States
(12) Patent Application Publication
(10) Pub. No.: US 2012/0023320 A1
(43) Pub. Date: Jan. 26, 2012

(54) BIOS CHIP RECOVERY SYSTEM AND COMPUTER THEREOF

(75) Inventors: HUNG-JU CHEN, Tu-Cheng (TW); LIANG-YAN DAI, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/982,902

(22) Filed: Dec. 31, 2010

(30) Foreign Application Priority Data
Jul. 23, 2010 (CN) 201010235048.2

(51) Int. Cl. G06F 15/177

(52) U.S. Cl. 713/2

(57) ABSTRACT

A computer having a BIOS recovery function includes a baseboard management controller (BMC) circuit, a main control circuit, a switching module and a BIOS chip. The switching module is connected to the BMC circuit and the main control circuit. The BIOS chip stores BIOS programs for the computer and is selectively connected to the BMC circuit and main control circuit by the switching module. When the BIOS programs are corrupted, the switching module selects the BMC circuit to communicate with the BIOS chip. New BIOS programs can be sent to the BIOS chip to update the corrupted BIOS programs.

### BACKGROUND

1. Technical Field

The disclosure generally relates to BIOS chip recovery systems, and particularly to a BIOS chip recovery system which includes a computer having a BIOS chip recovery function.

2. Description of Related Art

In a computer, a BIOS chip stores basic BIOS programs such as basic input/output program, system setting program, power on self test program, and system starting program to drive the computer system to be started and support the computer system to work normally. When the BIOS programs stored in the BIOS chip are corrupted and cannot be read, the computer system cannot be started normally. Therefore, it is needed to recover the information on the BIOS chip.

Therefore, there is room for improvement within the art.

### BRIEF DESCRIPTION OF THE DRAWINGS

Many aspects of the BIOS chip recovery system and computer thereof can be better understood with reference to the following drawings. The components in the drawings are not necessarily drawn to scale, the emphasis instead being placed upon clearly illustrating the principles of the BIOS chip recovery system and computer thereof.

FIG. 1 shows a BIOS chip recovery system, according to an exemplary embodiment.

FIG. 2 is a circuit diagram of the BIOS chip recovery system of one embodiment shown in FIG. 1.

### DETAILED DESCRIPTION

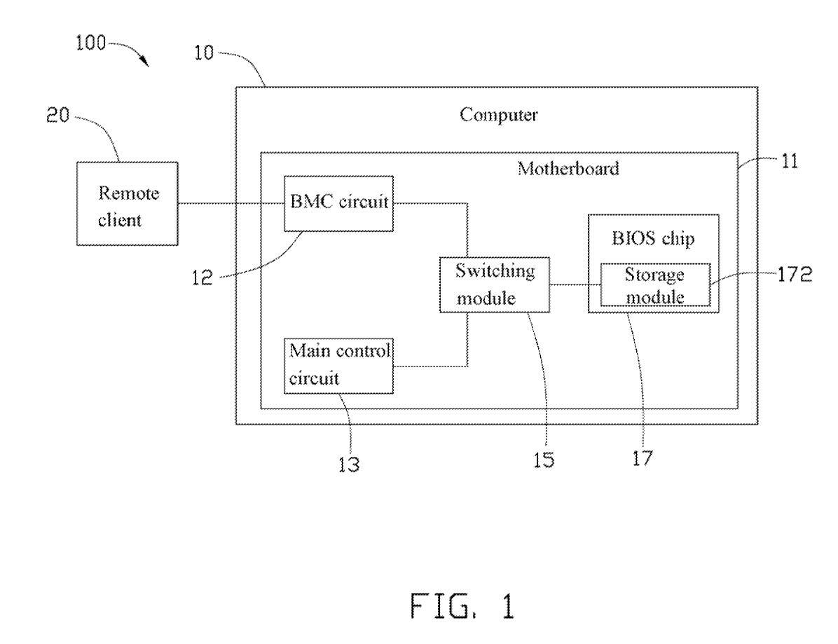

FIG. 1 shows a BIOS chip recovery system 100, according to an exemplary embodiment. The BIOS chip recovery system 100 includes a computer 10 having a BIOS chip recovery function and a remote client 20 electronically connected to the computer 10. The remote client 20 to recover a BIOS chip can control the computer.

The computer 10 includes a motherboard 11, a baseboard management controller (BMC) circuit 12, a main control circuit 13, a switching module 15, and a BIOS chip 17. The BMC circuit 12, the main control circuit 13, the switching module 15, and the BIOS chip 17 are included in the motherboard 11. The BIOS chip 17 is selectively connected to the BMC circuit 12 and the main control circuit 13 by the switching module 15.

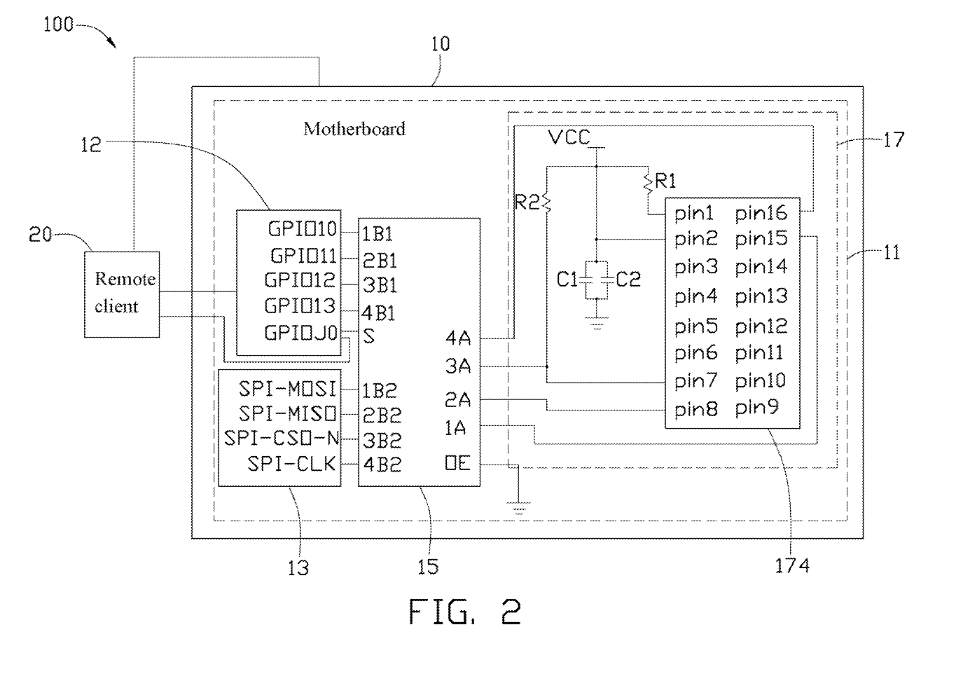

Referring to FIG. 2, the BMC circuit 12 includes a group of general purpose input and output (GPIO) contacts GPIO10-GPIO13 and a control contact GPIOJ0. The GPIO contacts GPIO10-GPIO13 and the control contact GPIOJ0 are electrically connected to the switching module 15.

The main control circuit 13 includes a group of data transmitting contacts SPI-MOSI [symbol] SPI-MISO [symbol] SPI-CS0-N and SPI-CLK electrically connected to the switching module 15.

The switching module 15 may be a SN74CBT3257 DBR type circuit which includes a first group of input contacts 1B1-4B1, a second group of input contacts 1B2-4B2, a group of output contacts 1A-4A, an enable contact OE and an input control contact S. The first group of input contacts 1B1-4B1 are connected to the GPIO contacts GPIO10-GPIO13, the second group of input contacts 1B2-4B2 are connected to the data transmitting contacts SPI-MOSI [symbol] SPI-MISO [symbol] SPI-CS0-N and SPI-CLK. The enable contact OE is grounded.

The input control contact S is connected to the control contact GPIOJ0 of the BMC circuit 12. The input control contact S selects the first group of contacts 1B1-4B1 or the second group of contacts 1B2-4B2 according to a control signal received from the BMC circuit 12. In this exemplary embodiment, when the control signal received from the control contact GPIOJ0 is a low level signal (e.g., logical 0), the switching module 15 selects the first group of input contacts 1B1-4B1 to connect to the group of the output contacts 1A-4A. That is, the BMC circuit 12 is selected to communicate with the BIOS chip 17. When the control signal received from the control contact GPIOJ0 is a high level signal (e.g., logical 1), the switching module 15 selects the second group of input contacts 1B2-4B2 to connect to the group of the output contacts 1A-4A. That is, the main control circuit 13 is selected to communicate with the BIOS chip 17.

The BIOS chip 17 includes a storage module 172 for storing BIOS programs for the computer 10. The BIOS chip 17 can read and execute the BIOS programs to initialize and start the computer 10. The storage module 172 includes a storage circuit 174, a first resistor R1, a second resistor R2, and two capacitors C1 and C2. The storage circuit 174 may be a flash memory including a plurality of contacts pin1-pin16. The contact pin1 is connected to a power supply VCC by the first resistor R1. The contact pin7 is connected to the power supply VCC by the second resistor R2. The contact pin2 is directly connected the power supply VCC. The contact pin7 is connected to the power supply VCC by a second resistor R2. The two capacitors C1 and C2 are connected in parallel between the contact pin 2 and ground. The four contacts pin7, pin 8, pin 15 and pin 16 are respectively connected to the output contacts 1A-4A of the switching module 15, thereby communicating with the BMC circuit 12 or the main control circuit 13.

The remote client 20 is connected to the control contact GPIOJ0. When the BIOS program stored in the BIOS chip 17 is corrupted (e.g., damaged, missing information) and the computer 10 cannot normally be started. The remote client 20 sends a control signal to the switching module 15 by the BMC circuit 12 to select the BMC circuit 12 to communicate with the BIOS chip 17; and then sends new BIOS programs prestored therein to the BIOS chip 17.

To recover the BIOS chip 17 when the BIOS program stored in the BIOS chip 17 is corrupted and the computer 10 cannot normally be started, the computer 10 sends a recovery request to the remote client 20. The remote client 20 receives the recovery request and sends a low level signal to the input control contact S by the control contact GPIOJ0 of the BMC circuit 12. The switching module 15 selects the BMC circuit 12 to communicate with the BIOS chip 17. The remote client 20 sends the new BIOS programs to the storage circuit 174 to update the corrupted BIOS programs. Thus, the BIOS chip 17 can read the new BIOS program and support the computer 10 to start.

After the BIOS chip is recovered, the control contact GPIOJ0 returns to a high level. The switching module 15 selects the main control circuit 13 to communicate with the storage circuit 174.

When the BIOS programs are corrupted, the BIOS recovery system 100 selects the BMC circuit 12 to communicate with the BIOS chip 17 and updates the BIOS programs stored in the BIOS chip 17 by the remote client 20 to normally start the computer 10.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments.

What is claimed is:

1. A computer having a BIOS recovery function, comprising:
a baseboard management controller (BMC) circuit;
a main control circuit;
a switching module connected to the BMC circuit and the main control circuit; and
a BIOS chip storing BIOS programs for the computer and selectively connected to the BMC circuit and main control circuit by the switching module; wherein when the BIOS programs are corrupted, the switching module selects the BMC circuit to communicate with the BIOS chip, new BIOS programs can be sent to the BIOS chip to update the corrupted BIOS programs.

2. The computer as claimed in claim 1, wherein the switching module includes a first group of input contacts connected to the BMC circuit, a second group of input contacts connected to the main control circuit, and a group of output contacts connected to the BIOS chip, the switching module can be controlled to select the BMC circuit or the main control circuit to communicate with the BIOS chip.

3. The computer as claimed in claim 2, wherein the BMC circuit includes a group of general purpose input and output contacts connected to the first group of input contacts of the switching module.

4. The computer as claimed in claim 2, wherein the main control circuit includes a group of data transmitting contacts connected to the second group of input contacts of the switching module.

5. The computer as claimed in claim 3, wherein the BMC circuit further includes a control contact, the switching module further includes an input control contact connected to the control contact of the BMC circuit, the input contact receives a control signal by the BMC circuit to select the BMC circuit or the main control circuit to communicate with the BIOS chip.

6. The computer as claimed in claim 1, wherein the BIOS chip includes a storage module includes a storage circuit for storing the BIOS programs.

7. The computer as claimed in claim 6, wherein the storage circuit is a flash memory.

8. A BIOS recovery system, comprising:
a computer; comprising:
a baseboard management controller (BMC) circuit;
a main control circuit;
a switching module connected to the BMC circuit and the main control circuit; and
a BIOS chip storing BIOS programs for the computer and selectively connected to the BMC circuit and main control circuit by the switching module; and
a remote client connected to the BMC circuit; wherein when the BIOS programs are corrupted, the remote client controls the switching module to select the BMC circuit to communicate with the BIOS chip, new BIOS programs prestored in the remote client can be sent to the BIOS chip to update the corrupted BIOS programs.

9. The BIOS recovery system as claimed in claim 8, wherein the switching module includes a first group of input contacts connected to the BMC circuit, a second group of input contacts connected to the main control circuit, and a group of output contacts connected to the BIOS chip, the switching module can be controlled to select the BMC circuit or the main control circuit to communicate with the BIOS chip.

10. The BIOS recovery system as claimed in claim 9, wherein the BMC circuit includes a group of general purpose input and output contacts connected to the first group of input contacts of the switching module.

11. The BIOS recovery system as claimed in claim 9, wherein the main control circuit includes a group of data transmitting contacts connected to the second group of input contacts of the switching module.

12. The BIOS recovery system as claimed in claim 10, wherein the BMC circuit further includes a control contact, the switching module further includes an input control contact connected to the control contact of the BMC circuit, the input contact receives a control signal by the BMC circuit to select the BMC circuit or the main control circuit to communicate with the BIOS chip.

13. The BIOS recovery system as claimed in claim 12, wherein the remote client is connected to the control contact of the BMC circuit and sends the control signal.

14. The BIOS recovery system as claimed in claim 9, wherein the BIOS chip includes a storage module includes a storage circuit for storing the new BIOS programs.

15. The BIOS recovery system as claimed in claim 13, wherein the storage circuit is a flash memory.
